(19) United States
(12) Patent Application Publication
(10) Pub. No.: US 2026/0066332 A1
(43) Pub. Date: Mar. 5, 2026

(54) BATTERY CELL PRESSURIZING DEVICE AND BATTERY CELL PRESSURIZING METHOD

(71) Applicant: SAMSUNG SDI CO., LTD., Yongin-si (KR)

(72) Inventor: Jiwon YUN, Yongin-si (KR)

(21) Appl. No.: 19/013,067

(22) Filed: Jan. 8, 2025

(30) Foreign Application Priority Data
Aug. 27, 2024 (KR) 10-2024-0115370

(51) Int. Cl. H01M 10/04; H01M 50/636

(52) U.S. Cl. CPC H01M 10/0468; H01M 10/0404; H01M 50/636

(57) ABSTRACT

A battery cell pressurizing device includes a battery cell arranger configured to arrange a battery cell, a battery cell pressurizer above the battery cell arranger, the battery cell pressurizer being configured to pressurize the battery cell, and an electrolyte injection port sealer above the battery cell pressurizer, the electrolyte injection port sealer being configured to seal an electrolyte injection port of the battery cell while the battery cell is pressurized by the battery cell pressurizer.

### CROSS-REFERENCE TO RELATED APPLICATION

This application claims priority under 35 U.S.C § 119 to Korean Patent Application No. 10-2024-0115370, filed in the Korean Intellectual Property Office on Aug. 27, 2024, the entire contents of which are hereby incorporated by reference.

### BACKGROUND

### 1. Field

Aspects of embodiments of the present disclosure relate to a battery cell pressurizing device and a battery cell pressurizing method.

### 2. Description of the Related Art

Unlike primary batteries that are not designed to be (re) charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage).

Secondary batteries may be classified into cylindrical type secondary batteries, prismatic type secondary batteries, pouch type secondary batteries, etc., depending on a shape of a case. A prismatic type secondary battery has a structure in which an electrode assembly is embedded in a prismatic metal can. The electrode assembly is inserted into the prismatic metal can, and a cap plate is welded to seal the can. An electrolyte is injected into an electrolyte injection port formed in the cap plate, and gases or the like formed inside the metal can during a formation process are discharged. Gases or the like inside the metal can are discharged and the electrolyte injection port is sealed.

The above information disclosed in this Background section is for enhancement of understanding of the background of the present disclosure, and therefore, it may contain information that does not constitute related (or prior) art.

### SUMMARY

According to an embodiment of the present disclosure, a battery cell pressurizing device may include a battery cell arranging part for arranging a battery cell in a battery cell pressurizing part, the battery cell pressurizing part for pressurizing the battery cell, and an electrolyte injection port sealing part for sealing an electrolyte injection port of the battery cell with a sealing member while the battery cell is pressurized by the battery cell pressurizing part.

According to one or more embodiments, the battery cell pressurizing part may include a pressurizing part arranged to pressurize a first surface of the battery cell and a second surface of the battery cell opposite to the first surface, a driving part for moving the pressurizing part in a first direction toward the first surface and a second direction toward the second surface, and a control part for controlling the operation of the driving part.

According to one or more embodiments, the pressurizing part may include a first pressurizing part arranged to face the first surface and pressurizing the first surface, and a second pressurizing part arranged to face the second surface and pressurizing the second surface.

According to one or more embodiments, each of the first pressurizing part and the second pressurizing part may include at least one pressurizing ball, and a pressurizing jig on which the at least one pressurizing ball may be arranged and which moves in parallel in the first direction and the second direction by the driving part.

According to one or more embodiments, the at least one pressurizing ball may be arranged on the pressurizing jig in a third direction crossing the first direction and the second direction.

According to one or more embodiments, the at least one pressurizing ball may include three pressurizing balls respectively arranged in first to third areas in the third direction in the pressurizing jig.

According to one or more embodiments, the battery cell arranging part arranges the battery cell so that the battery cell may be pressurized by the pressurizing ball between the first electrode tab and the second electrode tab of the battery cell.

According to one or more embodiments, a lower end of the first electrode tab may be arranged to be higher than a lower end of the second electrode tab with respect to the third direction, and the at least one pressurizing ball may include three pressurizing balls respectively arranged in first to third areas in the third direction between the first electrode tab and the second electrode tab.

According to one or more embodiments, a first pressurizing ball arranged in the first area may be arranged to be higher than the lower end of the first electrode tab between the first electrode tab and the second electrode tab.

According to one or more embodiments, a second pressurizing ball arranged in the second area may be arranged to be lower than the lower end of the first electrode tab and higher than the lower end of the second electrode tab between the first electrode tab and the second electrode tab.

According to one or more embodiments, a third pressurizing ball arranged in the third area may be arranged to be lower than the lower end of the second electrode tab between the first electrode tab and the second electrode tab.

According to one or more embodiments, the battery cell pressurizing part may include a plurality of the pressurizing parts.

According to one or more embodiments, the pressurizing ball may include a rubber material having elasticity.

According to one or more embodiments, the electrolyte injection port sealing part may seal the electrolyte injection port by pressurizing the sealing member into the electrolyte injection port.

According to one or more embodiments, the sealing member may be a ball having elasticity and including an aluminum material coated with a carbon material.

According to one or more embodiments of the present disclosure, a battery cell pressurizing method may include arranging, by a battery cell arranging part, a battery cell in a battery cell pressurizing part, pressurizing, by the battery cell pressurizing part, opposite surfaces of the arranged battery cell, and sealing, by an electrolyte injection port sealing part, an electrolyte injection port of the battery cell with a sealing member while the battery cell is pressurized.

According to one or more embodiments, the arranging of the battery cell may include arranging the battery cell in the battery cell pressurizing part so that the battery cell may be pressurized between the first electrode tab and the second electrode tab of the battery cell.

According to one or more embodiments, the battery cell pressurizing part may include at least one pressurizing ball, and a pressurizing jig for moving in parallel toward opposite surfaces of the battery cell and arranged in a direction crossing a direction in which the pressurizing ball moves in parallel, wherein the pressurizing of the battery cell may include pressurizing the pressurizing ball between the first electrode tab and the second electrode tab.

According to one or more embodiments, a lower end of the first electrode tab may be arranged to be higher than a lower end of the second electrode tab with respect to the crossing direction, and the at least one pressurizing ball may include three pressurizing balls respectively arranged in first to third areas in the crossing direction between the first electrode tab and the second electrode tab.

According to one or more embodiments, the pressurizing of the battery cell may include pressurizing the battery cell by a first pressurizing ball that is arranged in the first area to be higher than the lower end of the first electrode tab between the first electrode tab and the second electrode tab, pressurizing the battery cell by a second pressurizing ball that is arranged in the second area to be lower than the lower end of the first electrode tab and higher than the lower end of the second electrode tab between the first electrode tab and the second electrode tab, and pressurizing the battery cell by a third pressurizing ball that is arranged in the third area to be lower than the lower end of the second electrode tab between the first electrode tab and the second electrode tab.

### BRIEF DESCRIPTION OF THE DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings.

FIG. 1 illustrates a battery cell pressurizing device according to an embodiment of the present disclosure.

FIG. 2 illustrates a battery cell pressurizing part according to an embodiment of the present disclosure.

FIG. 3 illustrates a pressurizing ball according to an embodiment of the present disclosure.

FIG. 4 illustrates a pressurizing position of the battery cell according to an embodiment of the present disclosure.

FIG. 5 illustrates a battery cell pressurizing device according to an embodiment of the present disclosure.

FIGS. 6 to 9 illustrate views of stages in a battery cell pressurizing method according to an embodiment of the present disclosure.

FIG. 10 illustrates a flowchart of a battery cell pressurizing method according to an embodiment of the present disclosure.

### DETAILED DESCRIPTION

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

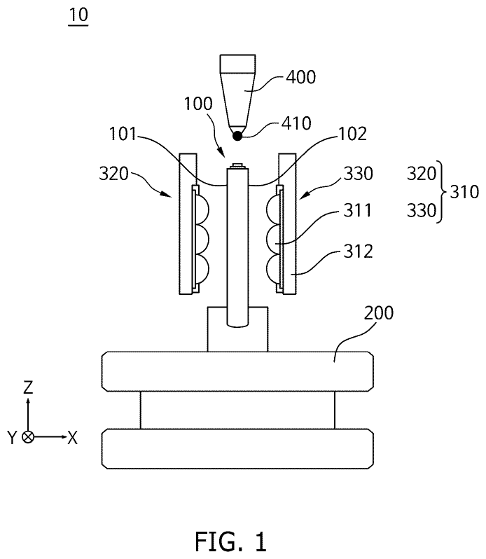

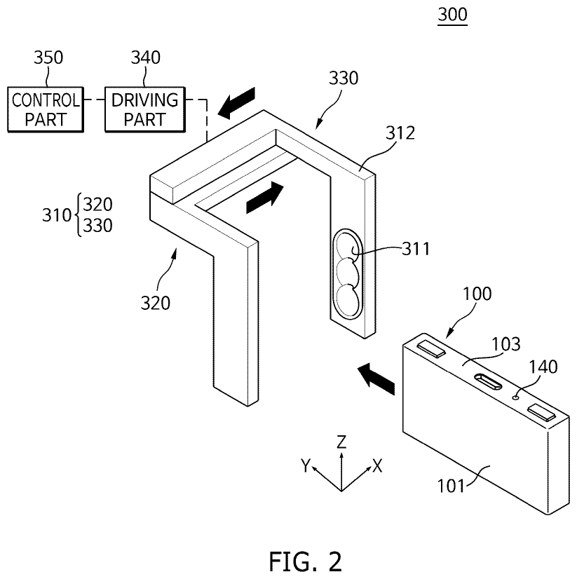

FIG. 1 illustrates a battery cell pressurizing device according to an embodiment of the present disclosure. FIG. 2 illustrates a battery cell pressurizing part according to an embodiment of the present disclosure.

In the present disclosure, a battery cell 100 according to an embodiment is described focusing on a prismatic battery, but the present disclosure may also be applied to other types of batteries having a rectangular appearance. However, for convenience of description, the following description focuses on a prismatic battery.

Referring to FIGS. 1 and 2, a battery cell pressurizing device 10 according to an embodiment of the present disclosure may include a battery cell arranging part 200, a battery cell pressurizing part 300, and an electrolyte injection port sealing part 400. For example, as illustrated in FIG. 1, the battery cell pressurizing part 300 may be positioned between the electrolyte injection port sealing part 400 and the battery cell arranging part 200, e.g., in the Z-axis direction. The battery cell 100 may be arranged in the battery cell pressurizing device 10 to be pressed.

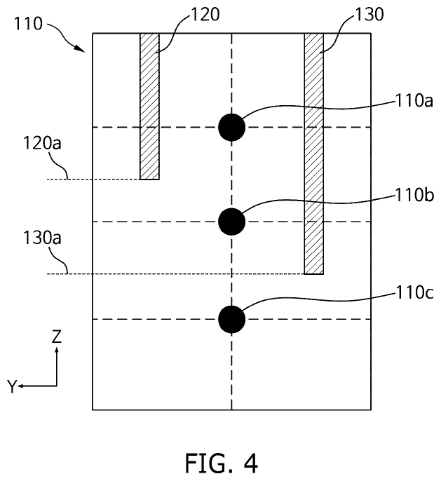

According to an embodiment, the battery cell 100 may include an electrode assembly (see 110 of FIG. 4). The electrode assembly 110 may include a first electrode, a second electrode, and a separator. For example, the first electrode may be a positive electrode and the second electrode may be a negative electrode, e.g., the opposite is also possible. For example, the electrode assembly 110 may be a wound electrode assembly formed by arranging a separator, which is an insulator, between the first electrode and the second electrode and then winding the separator. As another example, the electrode assembly 110 may be a stacked electrode assembly formed in a structure in which the first electrodes and the second electrode are alternately stacked with the separator therebetween, or may have any structure including the first electrode and the second electrode. The structure of the electrode assembly 110 described above is only an example.

According to an embodiment, the electrode assembly 110 may further include a first electrode tab (see 120 of FIG. 4) and a second electrode tab (see 130 of FIG. 4). The first electrode tab 120 may be formed separately and connected to an uncoated portion of the first electrode, or may be formed by punching a part of the uncoated portion of the first electrode. The first electrode tab 120 may extend from the uncoated portion and come into contact with a first electrode terminal. The first electrode tab 120 may serve as a path for a current flow between the first electrode and the first electrode terminal. The second electrode tab 130 may be formed separately and connected to an uncoated portion of the second electrode, or may be formed by punching a part of the uncoated portion of the second electrode. The second electrode tab 130 may extend from the uncoated portion and come into contact with a second electrode terminal. The second electrode tab 130 may serve as a path for a current flow between the second electrode and the second electrode terminal.

According to an embodiment, the battery cell arranging part 200 (e.g., a battery cell arranger) may hold and secure the battery cell 100 in a predetermined position relative to the battery cell pressurizing part 300, e.g., the battery cell arranging part 200 may be a stage or a frame with a hollow or a trench holding the battery cell 100. The battery cell arranging part 200 may be arranged under the battery cell pressurizing part 300 (e.g., so the battery cell pressurizing part 300 may vertically overlap the hollow or trench of the battery cell arranging part 200). The battery cell arranging part 200 may arrange the battery cell 100 to correspond to (e.g., overlap) the battery cell pressurizing part 300. The battery cell arranging part 200 may be arranged so that a first surface 101 and a second surface 102 of the battery cell 100 are pressurized, e.g., pressed, by the battery cell pressurizing part 300. The first surface 101 and the second surface 102 of the battery cell 100 may be the wide surfaces of the battery cell 100 that are opposite to each other and are perpendicular to a cap plate 103 in which an electrolyte injection port 140 is arranged.

According to an embodiment, the battery cell arranging part 200 may arrange the battery cell 100 between a first pressurizing part 320 and a second pressurizing part 330 of the battery cell pressurizing part 300. The battery cell arranging part 200 may arrange the battery cell 100 so that the first surface 101 of the battery cell 100 and the first pressurizing part 320 of the battery cell pressurizing part 300 face each other. The battery cell arranging part 200 may arrange the battery cell 100 so that the second surface 102 of the battery cell 100 and the second pressurizing part 330 of the battery cell pressurizing part 300 face each other.

According to an embodiment, the battery cell arranging part 200 may be arranged relative to the battery cell pressurizing part 300 so that the electrolyte injection port 140 of the battery cell 100 is located at the upper side (Z-axis direction). The battery cell arranging part 200 may arrange the battery cell 100 in the battery cell pressurizing part 300 so that the cap plate 103, in which the electrolyte injection port 140 of the battery cell 100 is arranged, is located at the upper side, e.g., so the cap plate 103 of the battery cell 100 may face away from the battery cell arranging part 200.

According to an embodiment, the battery cell arranging part 200 may arrange the battery cell 100 in the battery cell pressurizing part 300 so that the battery cell 100 is pressurized (e.g., contacted to be pressed) in a region between the first electrode tab 120 and the second electrode tab 130 of the battery cell 100. For example, if the battery cell 100 were to be pressurized in an area where the first electrode tab 120 and the second electrode tab 130 are arranged, the first electrode tab 120 and the second electrode tab 130 may be formed thicker than other areas of the electrode assembly 110, which may prevent the battery cell 100 from being pressurized. Accordingly, the battery cell arranging part 200 may arrange the battery cell 100 in the battery cell pressurizing part 300 so that the battery cell 100 may be pressurized (e.g., contacted and pressed) in a region between the first electrode tab 120 and the second electrode tab 130.

According to an embodiment, the battery cell pressurizing part 300 (e.g., a battery cell pressurizer) may pressurize (e.g., press) the battery cell 100. The battery cell pressurizing part 300 may pressurize the battery cell 100 arranged by the battery cell arranging part 200. The battery cell pressurizing part 300 may pressurize opposite surfaces 101 and 102 of the arranged battery cell 100 (e.g., press opposite surfaces 101 and 102 of the arranged battery cell 100 toward each other (e.g., along the X-axis direction).

According to an embodiment, the battery cell pressurizing part 300 may include a pressurizing part 310 (e.g., a pressurizer), a driving part 340 (e.g., a driver), and a control part 350 (e.g., a controller).

According to an embodiment, the pressurizing part 310 may be arranged to pressurize the first surface 101 and the opposite surface of the first surface 101 (i.e., the second surface 102) of the battery cell 100. The pressurizing part 310 may include the first pressurizing part 320 (e.g., a first pressurizer) that pressurizes the first surface 101 of the battery cell 100 and the second pressurizing part 330 (e.g., a second pressurizer) that pressurizes the second surface 102 of the battery cell 100.

According to an embodiment, the first pressurizing part 320 may be arranged to face the first surface 101 of the battery cell 100. The first pressurizing part 320 may be arranged to face the first surface 101 of the battery cell 100 and may move in a first direction (e.g., the X-axis direction) toward the first surface 101 to pressurize the first surface 101 of the battery cell 100.

According to an embodiment, the second pressurizing part 330 may be arranged to face the second surface 102 of the battery cell 100. The second pressurizing part 330 may be arranged to face the second surface 102 of the battery cell 100 and may pressurize the second surface 102 of the battery cell 100 by moving in a second direction (e.g., a direction opposite to the X-axis) opposite to the first direction toward the second surface 102.

According to an embodiment, each of the first pressurizing part 320 and the second pressurizing part 330 may include at least one pressurizing ball 311 and a pressurizing jig 312. According to an embodiment, the at least one pressurizing ball 311 may be arranged on the pressurizing jig 312.

In detail, referring to FIG. 2, the at least one pressurizing ball 311 may be arranged on the pressurizing jig 312 in a third direction (e.g., the Z-axis direction) crossing (e.g., perpendicular to) each of the first direction (e.g., X-axis direction) and the second direction (e.g., direction opposite to the X-axis). The first direction is a direction in which the first pressurizing part 320 faces the first surface 101 of the battery cell 100, and the second direction is a direction in which the second pressurizing part 330 faces the second surface 102 of the battery cell 100.

According to an embodiment, the at least one pressurizing ball 311 may include a rubber material having elasticity. For example, the at least one pressurizing ball 311 may include a rubber material such as natural rubber (NR), isoprene rubber (IR), butadiene rubber (BR), styrene butadiene rubber (SBR), and acrylonitrile butadiene rubber (NBR). The at least one pressurizing ball 311 may be elastically pressurized against the first surface 101 and the second surface 102 of the battery cell 100 to pressurize the battery cell 100.

According to an embodiment, the at least one pressurizing ball 311 may be arranged on the pressurizing jig 312. The pressurizing jig 312 may move in parallel in the first direction (e.g., the X-axis direction) and the second direction (e.g., the direction opposite to the X-axis) by the driving part 340. For example, the pressurizing jig 312 of the first pressurizing part 320 may move in parallel in the first direction so that the at least one pressurizing ball 311 may pressurize the first surface 101 of the battery cell 100. In addition, the pressurizing jig 312 of the second pressurizing part 330 may move in parallel in the second direction so that the at least one pressurizing ball 311 may pressurize the second surface 102 of the battery cell 100.

According to an embodiment, the driving part 340 may be connected to the pressurizing part 310 and may move the pressurizing part 310 in the first direction (X-axis direction) toward the first surface 101 of the battery cell 100 and the second direction (direction opposite to the X-axis) toward the second surface 102 of the battery cell 100. According to an embodiment, the driving part 340 may move the first pressurizing part 320 in the first direction (X-axis direction) toward the first surface 101 of the battery cell 100. The driving part 340 may move the second pressurizing part 330 in the second direction (direction opposite to the X-axis) toward the second surface 102 of the battery cell 100. The driving part 340 may provide power to enable the pressurizing part 310 to move. For example, the driving part 340 may include a driving shaft that provides a path along which the pressurizing jigs 312 of the first pressurizing part 320 and the second pressurizing part 330 may move in parallel, and a driving motor that transmits power to the driving shaft. For example, the driving part 340 may move the pressurizing jigs 312 of the first pressurizing part 320 and the second pressurizing part 330 toward each other.

According to an embodiment, the control part 350 may control the operation of the driving part 340. The control part 350 may control the operation of the driving part 340 so that the battery cell 100 may be pressurized by the pressurizing part 310. The control part 350 may control the operation of the driving part 340 based on the thickness of the battery cell 100, the case material of the battery cell 100, etc.

Referring to FIG. 1, according to an embodiment, the electrolyte injection port sealing part 400 (e.g., electrolyte injection port sealer) may seal the electrolyte injection port 140 by pressurizing the sealing member 410 into the electrolyte injection port 140. The electrolyte injection port sealing part 400 may seal the electrolyte injection port 140 by pressurizing the sealing member 410 into the electrolyte injection port 140 while the battery cell 100 is pressurized. Because the electrolyte injection port 140 of the battery cell 100 is sealed by the sealing member 410 in a pressurized state, the interior of the battery cell 100 may be maintained in a vacuum state.

According to an embodiment, the sealing member 410 may be a ball having elasticity and including an aluminum material coated with a carbon material. The diameter of the sealing member 410 may be formed to be longer than the diameter of the electrolyte injection port 140 formed in the cap plate 103. The sealing member 410 may seal the electrolyte injection port 140 by being press-fitted into the electrolyte injection port 140. Accordingly, the sealing member 410 may seal the electrolyte injection port 140 without separate welding.

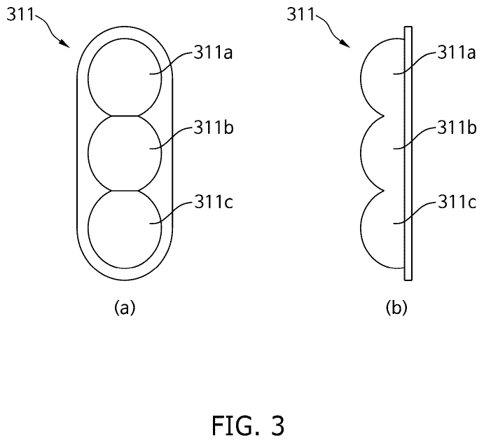

FIG. 3 illustrates the pressurizing ball according to an embodiment of the present disclosure. FIG. 4 illustrates the pressurizing position of the battery cell according to an embodiment of the present disclosure.

Referring to FIGS. 1 and 3-4, the battery cell arranging part 200 according to an embodiment may arrange the battery cell 100 in the battery cell pressurizing part 300 so that the battery cell 100 is pressurized by the at least one pressurizing ball 311 in a region between the first electrode tab 120 and the second electrode tab 130. As described above, in a case where pressurizing the battery cell 100 in an area where the first electrode tab 120 and the second electrode tab 130 are arranged, the first electrode tab 120 and the second electrode tab 130 may be formed thicker than other areas of the electrode assembly 110, which may prevent the battery cell 100 from being pressurized. Accordingly, the battery cell arranging part 200 may arrange the battery cell 100 in the battery cell pressurizing part 300 so that the battery cell 100 may be pressurized between the first electrode tab 120 and the second electrode tab 130.

According to an embodiment, the at least one pressurizing ball 311 may pressurize the battery cell 100 between the first electrode tab 120 and the second electrode tab 130. In a case where the at least one pressurizing ball 311 pressurizes the battery cell 100, the range in which the at least one pressurizing ball 311 is pressurized against the first surface 101 and the second surface 102 of the battery cell 100 may be formed between the areas where the first electrode tab 120 and the second electrode tab 130 are arranged. For example, the at least one pressurizing ball 311 may contact (e.g., directly contact) the battery cell 100 in a region between the first electrode tab 120 and the second electrode tab 130.

According to an embodiment, the at least one pressurizing ball 311 may include three pressurizing balls (e.g., a first pressurizing ball 311a, a second pressurizing ball 311b, and a third pressurizing ball 311c). Three pressurizing balls may be respectively arranged in the third direction (e.g., the Z-axis direction) to correspond to three area of the electrode assembly 110 (e.g., a first area 110a, a second area 110b, and a third area 110c). For example, the first pressurizing ball 311a, the second pressurizing ball 311b, and the third pressurizing ball 311c may be vertically aligned along a vertical portion of the pressurizing jig 312 (e.g., in the Z-axis direction) of each of the first and second pressurizing parts 320 and 330.

According to an embodiment, referring to FIG. 4, the first to third areas 110a, 110b, and 110c may correspond to (e.g., overlap) areas divided along the third direction (Z-axis direction) with respect to the electrode assembly 110 accommodated in the battery cell 100. The electrode assembly 110 may be divided into the first to third areas 110a, 110b, and 110c with the winding axis direction being in the third direction.

According to an embodiment, a lower end 120a of the first electrode tab 120 may be arranged to be higher in the electrode assembly 110 than a lower end 130a of the second electrode tab 130 (e.g., relative to a bottom of the electrode assembly 110). According to an embodiment, with respect to the electrode assembly 110 accommodated in the battery cell 100 arranged in the battery cell pressurizing part 300, the first area 110a may be an area higher than the lower end 120a of the first electrode tab 120 (e.g., relative to the bottom of the electrode assembly 110) between the first electrode tab 120 and the second electrode tab 130 of the electrode assembly 110. The second area 110b may be an area formed to be lower than the lower end 120a of the first electrode tab 120 and higher than the lower end 130a of the second electrode tab 130 (e.g., relative to the bottom of the electrode assembly 110) between the first electrode tab 120 and the second electrode tab 130 of the electrode assembly 110. The third area 110c may be an area formed to be lower than the lower end 130a of the second electrode tab 130 (e.g., relative to the bottom of the electrode assembly 110) between the first electrode tab 120 and the second electrode tab 130 of the electrode assembly 110.

According to an embodiment, the first pressurizing ball 311a may be arranged in the first area 110a (which is arranged to horizontally overlap the first area 110a of the electrode assembly 110). The first pressurizing ball 311a may be arranged to be higher than the lower end 120a of the first electrode tab 120 (e.g., relative to the bottom of the electrode assembly 110) between the first electrode tab 120 and the second electrode tab 130 to pressurize the first area 110a of the battery cell 100.

According to an embodiment, the second pressurizing ball 311b may be arranged in the second area 110b (which is arranged to horizontally overlap the second area 110b of the electrode assembly 110). The second pressurizing ball 311b may be arranged to be lower than the lower end 120a of the first electrode tab 120 and higher than the lower end 130a of the second electrode tab 130 (e.g., relative to the bottom of the electrode assembly 110) between the first electrode tab 120 and the second electrode tab 130 to pressurize the second area 110b of the battery cell 100.

According to an embodiment, the third pressurizing ball 311c may be arranged in the third area 110c (which is arranged to horizontally overlap the third area 110c of the electrode assembly 110). The third pressurizing ball 311c may be arranged to be lower than the lower end 130a of the second electrode tab 130 (e.g., relative to the bottom of the electrode assembly 110) between the first electrode tab 120 and the second electrode tab 130 to pressurize the third area 110c of the battery cell 100.

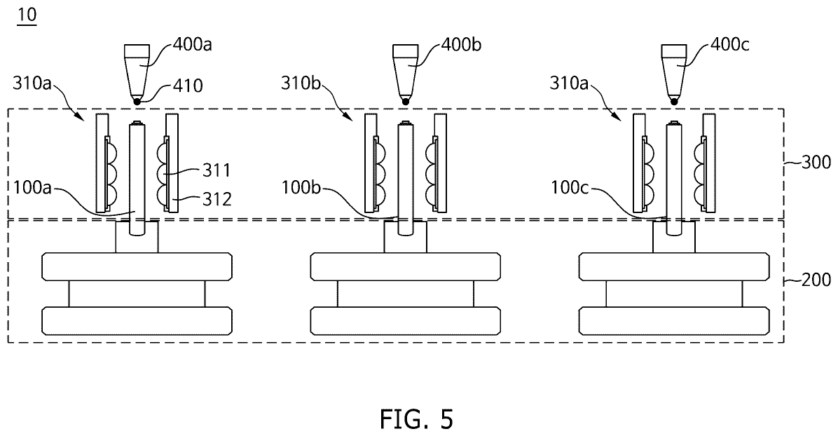

FIG. 5 illustrates a battery cell pressurizing device according to an embodiment of the present disclosure.

Referring to FIG. 5, the battery cell pressurizing part 300 according to an embodiment may include a plurality of pressurizing sub-parts 310a, 310b, and 310c. The battery cell pressurizing part 300 may simultaneously pressurize a plurality of battery cells 100a, 100b, and 100c. According to an embodiment, the battery cell arranging part 200 may arrange the battery cells 100a, 100b, and 100c in the plurality of pressurizing sub-parts 310a, 310b, and 310c, respectively, of the battery cell pressurizing part 300.

According to an embodiment, the pressurizing sub-parts 310a, 310b, and 310c may be connected to one driving part or a plurality of driving parts to operate. The pressurizing sub-parts 310a, 310b, and 310c may simultaneously pressurize the battery cells 100a, 100b, and 100c, or the pressurizing parts 310a, 310b, and 310c may sequentially pressurize the battery cells 100a, 100b, and 100c.

Other specific configurations of the battery cell pressurizing part 300 illustrated in FIG. 5 are the same as those of the battery cell pressurizing part 300 illustrated in FIG. 1, and thus, a detailed description thereof is omitted. For example, each of the plurality of pressurizing sub-parts 310a, 310b, and 310c may be identical to or similar to the battery cell pressurizing part 300 illustrated in FIG. 1.

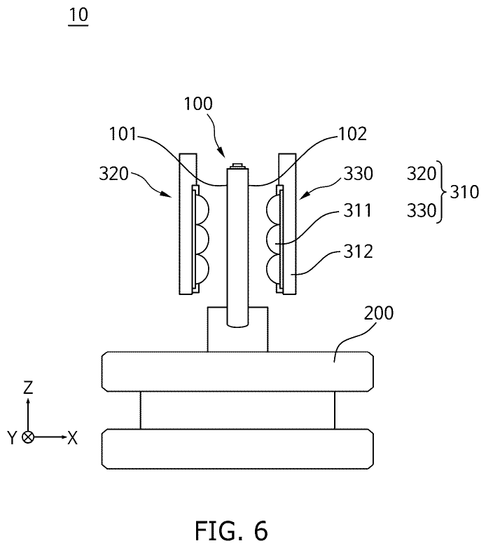

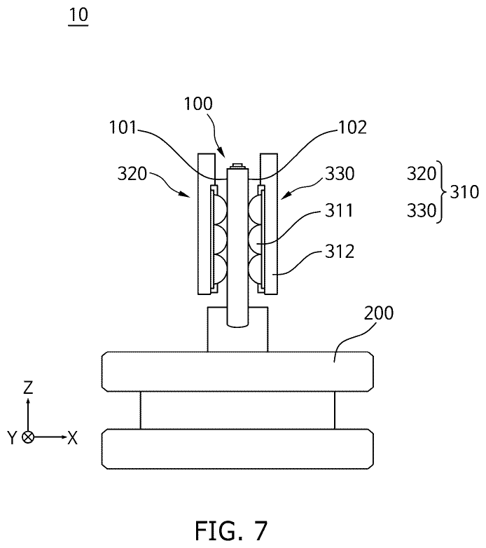

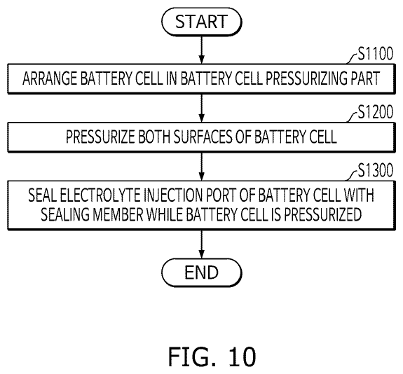

FIGS. 6 to 9 illustrate stages in a battery cell pressurizing method according to an embodiment of the present disclosure. FIG. 10 illustrates a flowchart showing a battery cell pressurizing method according to an embodiment of the present disclosure.

Hereinafter, each stage of the method of pressurizing the battery cell 100 according to an embodiment of the present disclosure is described in detail with reference to FIGS. 6 to 10.

Referring to FIG. 10, the battery cell arranging part 200 may arrange the battery cell 100 in the battery cell pressurizing part 300 (S1100). For example, referring to FIG. 6, the battery cell arranging part 200 according to an embodiment may arrange the battery cells 100 to correspond to the battery cell pressurizing part 300. The battery cell arranging part 200 may arrange the battery cells 100 so that the first surface 101 and the second surface 102 of the battery cell 100 are pressurized (e.g., pressed) by the battery cell pressurizing part 300. The first surface 101 and the second surface 102 of the battery cell 100 may be wide surfaces perpendicular to the cap plate (see 103 of FIG. 2) in which the electrolyte injection port 140 is arranged.

According to an embodiment, the battery cell arranging part 200 may arrange the battery cell 100 in the battery cell pressurizing part 300 so that the battery cell 100 is pressurized between the first electrode tab (see 120 of FIG. 4) and the second electrode tab (see 130 of FIG. 4) of the battery cell 100. For example, in a case where pressurizing the battery cell 100 in an area where the first electrode tab 120 and the second electrode tab 130 are arranged, the first electrode tab 120 and the second electrode tab 130 may be formed thicker than other areas of the electrode assembly (see 110 of FIG. 4), which may prevent the battery cell 100 from being pressurized. Accordingly, the battery cell arranging part 200 may arrange the battery cell 100 in the battery cell pressurizing part 300 so that the battery cell 100 may be pressurized between the first electrode tab 120 and the second electrode tab 130.

Referring again to FIG. 10, the battery cell pressurizing part 300 may pressurize opposite surfaces 101 and 102 of the battery cell 100 (S1200). For example, referring to FIGS. 4, 7, and 8, the battery cell pressurizing part 300 according to an embodiment may pressurize the battery cell 100. The battery cell pressurizing part 300 may pressurize the battery cell 100 arranged by the battery cell arranging part 200. The battery cell pressurizing part 300 may pressurize opposite surfaces 101 and 102 of the arranged battery cell 100.

According to an embodiment, the battery cell pressurizing part 300 may include the first pressurizing part 320 and the second pressurizing part 330. The first pressurizing part 320 may be arranged to face the first surface 101 of the battery cell 100 and may move in a first direction (X-axis direction) toward the first surface 101 to pressurize the first surface 101 of the battery cell 100. The second pressurizing part 330 may be arranged to face the second surface 102 of the battery cell 100 and may pressurize the second surface 102 of the battery cell 100 by moving in the second direction (direction opposite to the X-axis) toward the second surface 102.

According to an embodiment, each of the first pressurizing part 320 and the second pressurizing part 330 may include the at least one pressurizing ball 311 and the pressurizing jig 312. According to an embodiment, the at least one pressurizing ball 311 may be arranged on the pressurizing jig 312. The at least one pressurizing ball may be arranged on the pressurizing jig 312 in a third direction (Z-axis direction) crossing each of the first direction (X-axis direction) and the second direction (direction opposite to the X-axis). The first direction is a direction in which the first pressurizing part 320 faces the first surface 101 of the battery cell 100, and the second direction is a direction in which the second pressurizing part 330 faces the second surface 102 of the battery cell 100.

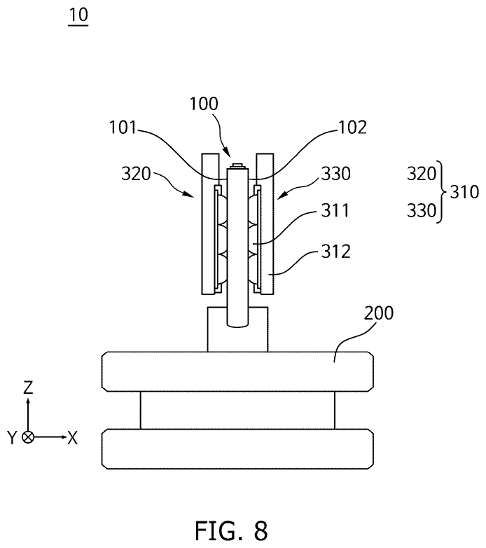

According to an embodiment, the at least one pressurizing ball 311 may include a rubber material having elasticity. For example, the at least one pressurizing ball 311 may include a rubber material such as natural rubber (NR), isoprene rubber (IR), butadiene rubber (BR), styrene butadiene rubber (SBR), and acrylonitrile butadiene rubber (NBR). The at least one pressuring ball 311 may be elastically pressurized against the first surface 101 and the second surface 102 of the battery cell 100 to pressurize the battery cell 100 (FIG. 8).

According to an embodiment, the at least one pressurizing ball 311 may be arranged on the pressurizing jig 312. The pressurizing jig 312 may move in parallel in the first direction (X-axis direction) and the second direction (direction opposite to the X-axis). For example, the pressurizing jig 312 of the first pressurizing part 320 may move in parallel in the first direction so that the at least one pressurizing ball 311 may pressurize the first surface 101 of the battery cell 100. In addition, the pressurizing jig 312 of the second pressurizing part 330 may move in parallel in the second direction so that the at least one pressurizing ball 311 may pressurize the second surface 102 of the battery cell 100.

According to an embodiment, the at least one pressurizing ball 311 may pressurize the battery cell 100 between the first electrode tab 120 and the second electrode tab 130. In a case where the at least one pressurizing ball 311 pressurizes the battery cell 100, the range in which the at least one pressurizing ball 311 is pressurized against the first surface 101 and the second surface 102 of the battery cell 100 may be formed between the areas where the first electrode tab 120 and the second electrode tab 130 are arranged.

According to an embodiment, the at least one pressurizing ball 311 may include three pressurizing balls (e.g., a first pressurizing ball 311a, a second pressurizing ball 311b, and a third pressurizing ball 311c). Three pressurizing balls may be respectively arranged in the third direction (e.g., the Z-axis direction) to correspond to three area of the electrode assembly 110 (e.g., a first area 110a, a second area 110b, and a third area 110c). According to an embodiment, the first to third areas 110a, 110b, and 110c may be areas divided along the third direction (Z-axis direction) with respect to the electrode assembly 110 accommodated in the battery cell 100. The electrode assembly 110 may be divided into the first to third areas 110a, 110b, and 110c with the winding axis direction being in the third direction.

According to an embodiment, the lower end 120a of the first electrode tab 120 may be arranged to be higher in the electrode assembly 110 than the lower end 130a of the second electrode tab 130. According to an embodiment, with respect to the electrode assembly 110 accommodated in the battery cell 100 arranged in the battery cell pressurizing part 300, the first area 110a may be an area higher than the lower end 120a of the first electrode tab 120 between the first electrode tab 120 and the second electrode tab 130 of the electrode assembly 110. The second area 110b may be an area formed to be lower than the lower end 120a of the first electrode tab 120 and higher than the lower end 130a of the second electrode tab 130 between the first electrode tab 120 and the second electrode tab 130 of the electrode assembly 110. The third area 110c may be an area formed to be lower than the lower end 130a of the second electrode tab 130 between the first electrode tab 120 and the second electrode tab 130 of the electrode assembly 110.

According to an embodiment, the first pressurizing ball 311a may be arranged in the first area 110a. The first pressurizing ball 311a may be arranged to be higher than the lower end 120a of the first electrode tab 120 between the first electrode tab 120 and the second electrode tab 130 to pressurize the first area 110a of the battery cell 100.

According to an embodiment, the second pressurizing ball 311b may be arranged in the second area 110b. The second pressurizing ball 311b may be arranged to be lower than the lower end 120a of the first electrode tab 120 and higher than the lower end 130a of the second electrode tab 130 between the first electrode tab 120 and the second electrode tab 130 to pressurize the second area 110b of the battery cell 100.

According to an embodiment, the third pressurizing ball 311c may be arranged in the third area 110c. The third pressurizing ball 311c may be arranged to be lower than the lower end 130a of the second electrode tab 130 between the first electrode tab 120 and the second electrode tab 130 to pressurize the third area 110c of the battery cell 100.

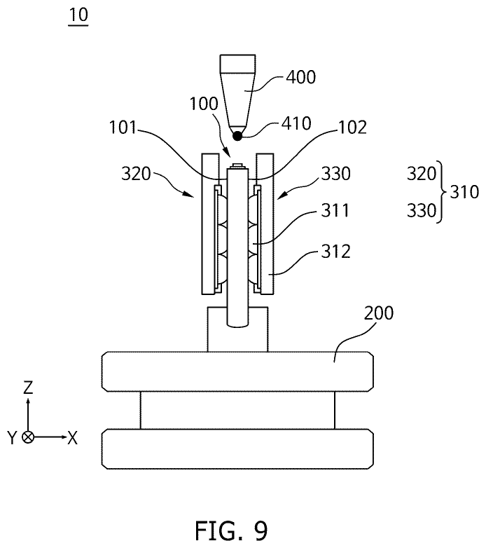

Referring again to FIG. 10, the electrolyte injection port sealing part 400 may seal the electrolyte injection port (see 140 of FIG. 2) of the battery cell 100 with the sealing member while the battery cell 100 is pressurized (S1300). For example, referring to FIG. 9, the electrolyte injection port sealing part 400 may seal the electrolyte injection port 140 by pressurizing the sealing member 410 into the electrolyte injection port 140. The electrolyte injection port sealing part 400 may seal the electrolyte injection port 140 by pressurizing the sealing member 410 into the electrolyte injection port 140 while the battery cell 100 is pressurized. Because the electrolyte injection port 140 of the battery cell 100 is sealed by the sealing member 410 in a pressurized state, the interior of the battery cell 100 may be maintained in a vacuum state.

According to an embodiment, the sealing member 410 may be a ball having elasticity and including an aluminum material coated with a carbon material. The diameter of the sealing member 410 may be formed to be longer than the diameter of the electrolyte injection port 140 formed in the cap plate (see 103 of FIG. 2). The sealing member 410 may seal the electrolyte injection port 140 by being press-fitted into the electrolyte injection port 140. Accordingly, the sealing member 410 may seal the electrolyte injection port 140 without separate welding.

By way of summation and review, if gas remains inside the metal can of the secondary battery after the formation process, it may deteriorate the battery performance and cause battery deterioration. Therefore, aspects of embodiments of the present disclosure provide a battery cell pressurizing device and a battery cell pressurizing method.

According to an embodiment of the present disclosure, by sealing the electrolyte injection port by inserting the sealing member into the electrolyte injection port while the battery cell is pressurized, gas generated inside the battery cell may be effectively removed. According to an embodiment of the present disclosure, the electrode assembly may be pressurized to increase adhesion between the first electrode, the separator, and the second electrode.

However, aspects and features of the present disclosure are not limited to those described above, and other aspects and features not mentioned will be clearly understood by a person skilled in the art from the detailed description, described above.

Although the present disclosure has been described above with respect to embodiments thereof, the present disclosure is not limited thereto. Various modifications and variations can be made thereto by those skilled in the art within the spirit of the present disclosure and the equivalent scope of the appended claims.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated.

Accordingly, it will be understood by those of skill in the art that various changes in form and details may be made without departing from the spirit and scope of the present invention as set forth in the following claims.

What is claimed is:

1. A battery cell pressurizing device, comprising:
a battery cell arranger configured to arrange a battery cell;
a battery cell pressurizer above the battery cell arranger, the battery cell pressurizer being configured to pressurize the battery cell; and
an electrolyte injection port sealer above the battery cell pressurizer, the electrolyte injection port sealer being configured to seal an electrolyte injection port of the battery cell while the battery cell is pressurized by the battery cell pressurizer.

2. The battery cell pressurizing device as claimed in claim 1, wherein the battery cell pressurizer includes:
a pressurizer above the battery cell arranger, the pressurizer being configured to press a first surface of the battery cell and a second surface of the battery cell opposite to the first surface;
a driver connected to the pressurizer, the driver being configured to move the pressurizer in a first direction toward the first surface and in a second direction toward the second surface; and
a controller configured to control the driver.

3. The battery cell pressurizing device as claimed in claim 2, wherein the pressurizer includes:
a first pressurizer arranged to face the first surface and configured to press the first surface; and
a second pressurizer arranged to face the second surface and configured to press the second surface.

4. The battery cell pressurizing device as claimed in claim 3, wherein each of the first pressurizer and the second pressurizer includes:
at least one pressurizing ball; and
a pressurizing jig, on which the at least one pressurizing ball is arranged, the pressurizing jig being configured to move in the first direction and the second direction by the driver.

5. The battery cell pressurizing device as claimed in claim 4, wherein the at least one pressurizing ball is arranged on the pressurizing jig in a third direction crossing the first direction and the second direction.

6. The battery cell pressurizing device as claimed in claim 5, wherein the at least one pressurizing ball includes three pressurizing balls respectively arranged in first to third areas in the third direction in the pressurizing jig.

7. The battery cell pressurizing device as claimed in claim 5, wherein the battery cell arranger is configured to arrange the battery cell so that the battery cell is pressurized by the at least one pressurizing ball between a first electrode tab and a second electrode tab of the battery cell.

8. The battery cell pressurizing device as claimed in claim 7, wherein:
a lower end of the first electrode tab is arranged to be higher than a lower end of the second electrode tab with respect to the third direction, and
the at least one pressurizing ball includes three pressurizing balls respectively arranged in first to third areas in the third direction between the first electrode tab and the second electrode tab.

9. The battery cell pressurizing device as claimed in claim 8, wherein a first pressurizing ball arranged in a first area is arranged to be higher than the lower end of the first electrode tab between the first electrode tab and the second electrode tab.

10. The battery cell pressurizing device as claimed in claim 8, wherein a second pressurizing ball arranged in the second area is arranged to be lower than the lower end of the first electrode tab and higher than the lower end of the second electrode tab between the first electrode tab and the second electrode tab.

11. The battery cell pressurizing device as claimed in claim 8, wherein a third pressurizing ball arranged in the third area is arranged to be lower than the lower end of the second electrode tab between the first electrode tab and the second electrode tab.

12. The battery cell pressurizing device as claimed in claim 4, wherein the at least one pressurizing ball includes a rubber material having elasticity.

13. The battery cell pressurizing device as claimed in claim 2, wherein the battery cell pressurizer includes a plurality of pressurizing sub-parts.

14. The battery cell pressurizing device as claimed in claim 1, wherein the electrolyte injection port sealer is configured to seal the electrolyte injection port by pressurizing a sealing member into the electrolyte injection port.

15. The battery cell pressurizing device as claimed in claim 1, wherein the sealing member is a ball having elasticity and including an aluminum material coated with a carbon material.

16. A battery cell pressurizing method, comprising:
arranging, by a battery cell arranger, a battery cell in a battery cell pressurizer;
pressurizing, by the battery cell pressurizer, opposite surfaces of the battery cell; and
sealing, by an electrolyte injection port sealer, an electrolyte injection port of the battery cell with a sealing member while the battery cell is pressurized.

17. The battery cell pressurizing method as claimed in claim 16, wherein arranging the battery cell includes arranging the battery cell in the battery cell pressurizer so that the battery cell is pressurized between a first electrode tab and a second electrode tab of the battery cell.

18. The battery cell pressurizing method as claimed in claim 17, wherein:
the battery cell pressurizer includes:
at least one pressurizing ball; and
a pressurizing jig for moving in parallel toward opposite surfaces of the battery cell and arranged in a direction crossing a direction in which the at least one pressurizing ball moves in parallel, and
pressurizing the battery cell includes pressurizing the at least one pressurizing ball between the first electrode tab and the second electrode tab.

19. The battery cell pressurizing method as claimed in claim 18, wherein:
a lower end of the first electrode tab is arranged to be higher than a lower end of the second electrode tab with respect to a crossing direction, and
the at least one pressurizing ball includes three pressurizing balls respectively arranged in first to third areas in the crossing direction between the first electrode tab and the second electrode tab.

20. The battery cell pressurizing method as claimed in claim 19, wherein the pressurizing of the battery cell includes:
pressurizing the battery cell by a first pressurizing ball that is arranged in the first area to be higher than the lower end of the first electrode tab between the first electrode tab and the second electrode tab;
pressurizing the battery cell by a second pressurizing ball that is arranged in the second area to be lower than the lower end of the first electrode tab and higher than the lower end of the second electrode tab between the first electrode tab and the second electrode tab; and
pressurizing the battery cell by a third pressurizing ball that is arranged in the third area to be lower than the lower end of the second electrode tab between the first electrode tab and the second electrode tab.
